(19) United States
(12) Patent Application Publication
(10) Pub. No.: US 2021/0395127 A1
(43) Pub. Date: Dec. 23, 2021

(54) SUBMERGED BURNER FURNACE

(71) Applicant: SAINT-GOBAIN ISOVER, COURBEVOIE (FR)

(72) Inventors: Christopher ELLISON, VARENGEVILLE-SUR-MER (FR); Antoine GUILLET, PARIS (FR); Philippe MORIN, HRADEC KRALOVE (CZ); Patrick KOWALEWSKI, BEAUVAIS (FR)

(21) Appl. No.: 17/279,329

(22) PCT Filed: Sep. 25, 2019
(86) PCT No.: PCT/FR2019/052251

§ 371 Date: Mar. 24, 2021

(30) Foreign Application Priority Data
Sep. 28, 2018 (FR) 1858984

(51) Int. Cl. C03B 3/02; C03B 5/00; C03B 5/12; C03B 5/235; C03B 3/00

(52) U.S. Cl. CPC C03B 3/02; C03B 5/005; C03B 5/12; C03B 2211/40; C03B 3/005; C03B 5/2353; C03B 2211/23; C03B 5/2356

(57) ABSTRACT

A for melting batch material includes a furnace equipped with a submerged burner, a system for supplying the submerged burner with fuel gas and with oxidizer, a system for supplying the furnace with raw material including fragments of mineral wool below the surface of the molten batch materials, a system for supplying the furnace with raw material including a vertical duct for receiving raw material through its upper side and for conveying this raw material downward toward the molten batch materials. The duct receives the combustion flue gases originating from the furnace and conveys them upward through the raw material in the duct. A system supports the solid raw material in the duct and is positioned above the surface of the molten batch material and retains the solid raw material in the duct and lets descending molten raw material pass through to fall into the molten batch material.

The invention relates to a submerged burner furnace particularly suitable for recycling fragments of mineral wool and the energy efficiency of which is advantageous.

U.S. Pat. No. 3,294,505 teaches the melting of batch materials in a cupola furnace, according to which raw materials mixed with coke are introduced into a vertical duct, an upflow of air passing through the raw materials in order to burn the coke, heat and give rise to the melting of these materials. The molten batch material is recovered at a level below the mixture of raw materials and coke. The coke is however a very significant source of CO₂. Furthermore, it is difficult to introduce raw material of small particle size, such as fragments of mineral wool, into this furnace since the strong upward gas streams entrain it into the stacks.

EP 2100858 A1 proposed replacing the coke with natural gas, using overhead burners. Raw materials are introduced into a vertical duct and are retained by a grate, an upflow of combustion gas originating from overhead burners placed between the molten material and the grate passes through the grate then the raw materials, giving rise to the melting of these materials. The molten batch material is recovered in a tank below the grate, said molten batch material then being discharged by flow through an orifice.

The inventors of the present invention, having tested the latter type of configuration, however observed the following drawbacks:
fragments of mineral wool added to the raw material volatilize too easily considering the strong gas flows passing through the raw material countercurrently or tend to block the passage of said gas flows through the raw material feedstock, reducing the energy efficiency of the system; to overcome this drawback, the fragments of mineral wool may be compacted in the form of briquettes bound by a cement-type binder, but this requires a costly additional preparation and the melting of the cement of the briquettes generates undesired emissions of sulfur oxides;
the temperature of the molten material reaches a maximum at around 1450° C., which is too low for certain applications; the replacement of air as oxidizer with oxygen makes it possible to increase the temperature but this leads to an unacceptable energy cost.

The analysis of the operation of the furnaces described above has shown that the radiations of flames of overhead burners pass so badly through the molten batch material that the heat transfer provided by these overhead burners is in fact essentially limited to the duration of flow of the molten material of the raw material above the grate to the surface of the molten mass below the grate, without being able to penetrate into the depth of the molten bath. As regards this molten mass in the tank, the overhead burners heat only its surface with no great effect for the molten material at greater depth. In order to achieve the desired temperature (in particular around 1550° C.) in the molten batch material, the use of pure oxygen is needed but it is additionally necessary to produce an enormous and very costly combustion energy.

A furnace has now been designed that satisfies the aforementioned drawbacks, said furnace combining the following elements:
the batch material in the tank is heated by submerged combustion; heat is therefore directly introduced into the molten material and the absorption of the radiations of the flames by the molten material has a relatively moderate effect on the effective heat transfer;
the submerged combustion is carried out by combustion of fuel gas (producing less CO₂ than coke), in particular of natural gas with an oxidizer, preferably rich in oxygen (i.e. having at least 80% by volume of oxygen); as the combustion is carried out within the molten material, the energy transfer is excellent and does not require a high excess of combustion to reach the desired temperature, generally above 1500° C.;
the fragments of mineral wool are introduced into the tank below the level of the molten materials so that they do not volatilize; the submerged combustion leads to the rapid melting of these fragments of mineral wool.

Thus the invention relates firstly to a device for melting batch material comprising a furnace equipped with at least one submerged burner, a system for supplying the submerged burner with fuel gas and with oxidizer, which preferably comprises at least 80% by volume of oxygen, a system for supplying the furnace with raw material comprising fragments of mineral wool below the surface of the molten batch materials, a system for supplying the furnace with raw material comprising a vertical duct capable of receiving raw material through its upper side and capable of conveying this raw material downward above the molten batch materials, said duct being capable of receiving the combustion flue gases originating from the furnace and of conveying them upward through the raw material in the duct, a means for supporting the solid raw material in the duct, said means being positioned above the surface of the molten batch material and capable of retaining the solid raw material in the duct and capable of letting descending liquid raw material pass through in order to fall into the molten batch material and capable of letting the combustion flue gases originating from the furnace pass through in order to rise in the duct.

The support means generally comprises a grate positioned substantially horizontally above the bath of molten batch material. The raw material introduced into the duct may rest directly on the grate if the particle size of this raw material and the mesh size of the grate enable the grate to retain this raw material. It is also possible to place directly on the grate a bed of refractory balls before introducing the raw material into the duct. These balls are not primarily intended to act as raw material but it is not excluded for them to enrich the batch material slightly with a compound, in particular with alumina.

The system for supplying the submerged burner with fuel gas and with oxidizer preferably comprising at least 80% by volume of oxygen comprises sources of fuel gas and of this oxidizer, pipes for supplying the submerged burner with fuel gas and with this oxidizer, a system for regulating the amounts of fuel gas and of this oxidizer supplying the submerged burner.

Raw material is introduced solid by the upper side of the duct and melts above the means for supporting this raw material, the molten raw material falling into the bath of molten batch material in the furnace. This raw material is therefore introduced in the molten state into the mass of molten batch material by falling in liquid form (drops or liquid streams) onto the surface of the bath of molten batch material. The vertical duct has a three-fold role: —supplying with raw material, —discharging the flue gases, —heat exchanger by enabling the heating of the raw material in the duct via the flue gases. The duct is vertical insofar as the direction of transport of the raw material that it contains comprises a vertical component, or even is essentially vertical, gravity being sufficient for this raw material to descend in the duct under the effect of its own weight. The duct may therefore be inclined as long as the material that it contains can descend by itself under the effect of gravity. Thus, the duct, referred to as a vertical duct, is a duct capable of transporting the raw material with a vertical component downward under the effect of gravity.

The expression “fragments of mineral wool” denotes any residues derived from the production of mineral wool, including mineral materials solidified in the form of grains or unfiberized materials, or recovered in the form of solid fly-off materials, or bundles of fibers recovered (by washing operations) on the various receiving or conveying surfaces, and also cut mineral wool felt. This waste may also be derived from deconstruction. It is therefore waste well known to a person skilled in the art and that it is proposed to recycle within the context of the present invention without needing to convert it beforehand into briquettes. The fragments of mineral wool generally comprise a rock wool or a glass wool and a binding compound to bind the fibers of the wool. This binding compound may be mineral but is generally organic. The binding compound included in the fragments of mineral wool is generally present in a proportion of from 0.1% to 10% by weight and more particularly in a proportion of from 0.5% to 7% by weight of binding compound solids relative to the total weight of fragments of dry wool. The organic material of the binding compound burns off in the furnace.

The mineral wool generally comprises (excluding binding compound):

SiO₂: 30% to 75% by weight,

CaO+MgO: 5% to 40% by weight,

Al₂O₃: 0 to 30% by weight,

Na₂O+K₂O: 0 to 20% by weight,

iron oxide: 0 to 15% by weight.

The main components of a rock wool (also referred to as “black glass wool” by a person skilled in the art) are generally (excluding binding compound):

SiO₂: 30% to 50% by weight,

Al₂O₃: 10% to 22% by weight,

CaO+MgO: 20% to 40% by weight,

iron oxide: 3% to 15% by weight.

The main components of a glass wool are generally (excluding binding compound):

SiO₂: 50% to 75% by weight,

Al₂O₃: 0 to 8% by weight,

CaO+MgO: 5% to 20% by weight,

iron oxide: 0 to 3% by weight,

Na₂O+K₂O: 12% to 20% by weight,

B₂O₃: 2% to 10% by weight.

Within the context of the invention, the fragments of mineral wool are a raw material. Besides supplying the furnace with mineral wool, the furnace is also supplied with raw material different from the fragments of mineral wool. This may be powder, granules, balls, agglomerates, pebbles, stones, rocks, the shapes of all these elements being considered to be “granular”. These granular shapes may be regular, since they have been shaped, or irregular, since they originate directly from quarries or manufacturing processes that do not lead to a regular shape. In particular, agglomerates, granules or balls may be produced by powder compacting via a roller compactor or a drum granulator, generally also by means of the presence of a binder. Depending on its particle size, the raw material is introduced either by the vertical duct above the bath of molten batch material (large particle size), or below the surface of the bath of molten batch material (small particle size). Indeed, the volatile raw material is preferably introduced below the surface of the bath of molten batch material, and the non-volatile raw material is preferably introduced through the upper side of the vertical duct. The volatility considered is that with respect to the combustion flue gases. Fragments of mineral wool and raw material powder are volatile and therefore introduced below the surface of the bath of molten batch material.

Thus, the raw material introduced into the vertical duct is preferably such that at least 80% or even at least 90% of its mass consists of grains with a size of greater than 30 mm, generally with a size of between 40 and 500 mm. This raw material is generally free of fragments of mineral wool. Briquettes produced by compacting fragments of mineral wool are not considered here to be fragments of mineral wool. The raw material comprising fragments of mineral wool introduced below the surface of the molten batch material may comprise raw material different from the fragments of mineral wool, at least 80% or even at least 90% or even 100% of the mass of this different raw material consisting of grains with a size of less than 30 mm. The size of a grain is the distance between the two furthest apart points thereof.

The raw material comprises various compounds necessary for the production of the desired composition of batch material. It generally comprises silica and at least one alkaline-earth metal and/or alkali metal carrier such as calcium carbonate, magnesium carbonate, sodium carbonate.

The raw material comprising the fragments of mineral wool is introduced below the surface of the molten batch materials, for example via at least one screw conveyor, in particular as described in WO 2013/132184. Thus, the system for supplying the furnace with raw material below the surface of the molten batch materials generally comprises at least one screw conveyor. The raw material comprising the fragments of mineral wool may also be introduced below the surface of the molten batch materials with the aid of a piston system pushing it into the furnace. Generally, it is advantageous to have a system capable of pushing, into the molten batch materials, the raw material to be introduced below the surface of the molten batch materials.

The furnace comprises a vertical duct that leads raw material downward toward the surface of the molten batch materials. This raw material is introduced into this duct through its upper side. A means for supporting this solid raw material positioned above the surface of the molten batch materials, either below the lower end of the duct or in the duct (in the lower part thereof), retains this solid raw material. The combustion gases coming from below this support means pass through it and progress upward, through and countercurrent to the raw material in the duct. These gases heat this raw material until it melts and the molten raw material descends, passes through the support means downward and reaches the molten batch material in the furnace by falling in the liquid state onto the surface of the bath of batch material. Thus, the combustion flue gases are discharged through the duct countercurrently to the raw material that it contains. The raw material passed through the vertical duct and the raw material introduced below the surface of the liquid bath mix together in the tank of the furnace to produce the molten batch material. The support means is permeable to the molten raw material passing downward through it and permeable to the combustion gases passing upward through it.

Generally, the mass of raw material introduced below the surface of the molten batch material represents 5% to 70% of the sum of the masses of all the raw materials introduced into the device. The mass of fragments of mineral wool generally represents 50% to 100% of the sum of the mass of raw material introduced below the surface of the bath of batch material. The system for supplying below the surface of the molten batch materials is capable of introducing into the furnace a raw material comprising 50% to 100% of fragments of mineral wool by mass.

Generally, the raw material introduced below the surface of the molten batch material has a chemical composition different from that introduced through the upper side of the duct.

The means for supporting the solid raw material in the duct may comprise a grate on which a bed of balls directly rests. These refractory balls also act as a grate and slow down the descent of raw material in the duct. These refractory balls may be of oxide type. They generally comprise at least 25% by weight of alumina, more generally 25% to 90% by weight of alumina. Generally, the refractory balls have a size of between 5 and 30 cm. The size of a refractory ball is understood to mean the distance between the 2 furthest apart points thereof. These refractory balls are sufficiently refractory to be essentially infusible in the stream of combustion flue gases. However, it has been observed that alumina-containing refractory balls can, in spite of everything, play a part in enriching the molten batch material with alumina. Thus, preferably, alumina-containing refractory balls rest on the grate, the solid raw material in the duct resting on these balls.

The grate may comprise metal tubes through which cooling water passes. The metal of these tubes is sufficiently resistant with respect to the medium in question. It may be made of steel.

The furnace may also be equipped with at least one overhead burner, the flame of which is emitted above the surface of the molten batch materials and below the means for supporting the solid raw material in the duct, in particular a grate of the support means. In this case, an overhead burner passes through a side wall or the crown of the furnace.

The invention also relates to a process for preparing molten batch material comprising the melting of batch material by the device according to the invention, raw material comprising fragments of mineral wool being introduced into the furnace below the surface of the molten batch material, raw material being introduced into the vertical duct, descending in the duct and being heated therein by the combustion flue gases until it melts and flows onto the surface of the molten batch material, the submerged burner operating by combustion of fuel gas and of an oxidizer preferably comprising at least 80% by volume of oxygen.

The oxidizer supplying the submerged burner is gaseous. It preferably comprises at least 80% by volume of oxygen. It may be oxygen-enriched air or pure oxygen. The fuel supplying the submerged burner is gaseous and is generally natural gas. The combustion in the furnace is sufficiently energetic so that the flue gases are hot enough to melt the raw material above the means for supporting the solid raw material in the duct. The use of an oxygen-rich oxidizer makes it possible to minimize the production of NOx and also to minimize the volume of combustion gas produced compared to a combustion with air. It is thus possible to produce extremely hot flue gases that manage both to heat the molten mass to in particular more than 1500° C. and to melt the solid raw material above the means for supporting the solid raw material in the duct.

The batch material may be heated in the furnace to a temperature above 1400° C., or even above 1450° C., or even above 1500° C., or even above 1550° C. and generally below 1600° C. The batch material may be heated in the furnace to a temperature between 1400° C. and 1600° C.

The tank of the furnace is advantageously made of metal cooled by a flow of water, a system which is referred to by a person skilled in the art as a “water jacket”. The submerged burner is advantageously also made of metal cooled by a flow of water. The furnace is advantageously equipped with one or more submerged burners. A submerged burner used within the context of the present invention may be of cylindrical shape as shown in FIG. 5 of WO 99/35099. It may also be of linear shape as taught by WO 2013/117851, a shape particularly suitable for the present invention.

The device according to the invention is intended for the preparation of a molten batch material, generally of oxide type, generally comprising at least 30% by mass of silica, such as a glass or a silicate, for instance an alkali metal and/or alkaline-earth metal silicate. The batch material thus prepared may have one of the compositions given above for the mineral wool, in particular glass wool or rock wool (the term “rock” denoting here a type of composition and not an appearance). Generally, the batch material comprises 30% to 75% by weight of SiO₂ and 5% to 40% by weight of (CaO+MgO).

The batch material may in particular be used for the manufacture of fibers or of mineral wool. Thus, the device according to the invention may be followed by a fiberizing member for the manufacture of fibers or of mineral wool.

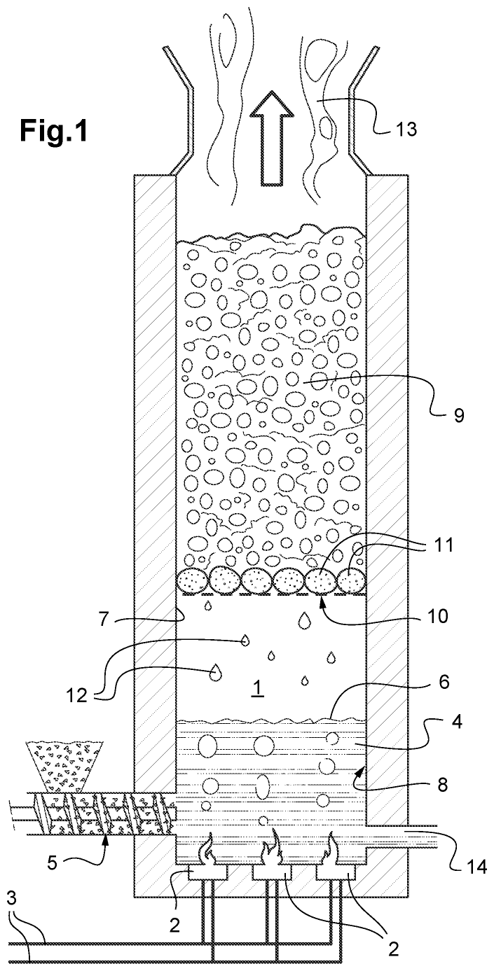

FIG. 1 represents an example of a device according to the invention seen in side cross section. This device comprises a furnace 1 equipped with submerged burners 2 mounted in the floor. These submerged burners are supplied, by means of a supply system 3, with fuel gas and with oxidizer. The submerged burners provide flames in the mass 4 of the bath of molten batch materials. A screw conveyor type system 5 makes it possible to supply the furnace with fragments of mineral wool and if necessary with raw material different from the wool and having a small particle size below the surface 6 of the molten batch materials. A vertical duct 7 above the surface of the molten batch material 4 makes it possible to supply the tank 8 of the furnace with raw material 9 of large particle size. The raw material 9 is introduced through the upper end of the duct 7 and is retained above the surface 6 of the molten batch material by a support means comprising a grate 10 and alumina-rich balls 11 resting on the grate. The combustion flue gases generated by the burners and below the grate pass through the grate and the balls and rise into the duct 7 acting as a stack, through the raw material 9. This raw material is thus heated by these flue gases and gradually melted. The molten raw material 12 flows through the means (grate+balls) for supporting the solid raw material in the duct and falls into the mass 4 of molten batch materials. The combustion flue gases 13 that are passed through the raw material in the duct 7 are discharged via the upper end of the duct 7. The molten batch material may be discharged through an orifice 14 in a wall of the tank 8 of the furnace.

1. A device for melting batch material comprising a furnace equipped with at least one submerged burner, a system for supplying the submerged burner with fuel gas and with oxidizer, a system for supplying the furnace with raw material comprising fragments of mineral wool below a surface of the molten batch materials, a system for supplying the furnace with raw material comprising a vertical duct capable of receiving raw material through its upper side and capable of conveying the raw material with a direction of transport comprising a vertical component downward under the effect of its own weight above the molten batch materials, said vertical duct being capable of receiving the combustion flue gases originating from the furnace and of conveying them upward through the raw material in the vertical duct, a system for supporting the solid raw material in the vertical duct, said system being positioned above the surface of the molten batch material and capable of retaining the solid raw material in the vertical duct and capable of letting descending molten raw material pass through in order to fall into the molten batch material and capable of letting the combustion flue gases originating from the furnace pass through in order to rise in the vertical duct.

2. The device as claimed in claim 1, wherein the system for supplying the furnace with raw material below the surface of the molten batch materials is capable of pushing the raw material into the molten batch materials.

3. The device as claimed in claim 1, wherein the system for supplying below the surface of the molten batch materials is capable of introducing into the furnace a raw material comprising 50% to 100% of fragments of mineral wool by mass.

4. The device as claimed in claim 1, wherein the system for supplying the furnace with raw material below the surface of the molten batch materials comprises at least one screw conveyor.

5. The device as claimed in claim 1, wherein the system for supplying the furnace with raw material below the surface of the molten batch materials comprises at least one piston.

6. The device as claimed in claim 1, wherein the oxidizer comprises at least 80% by volume of oxygen.

7. The device as claimed in claim 1, wherein the system for supporting the solid raw material in the vertical duct comprises a grate.

8. The device as claimed in claim 7, wherein the grate comprises metal tubes through which cooling water passes.

9. The device as claimed in claim 1, wherein alumina-containing refractory balls rest on the grate.

10. The device as claimed in claim 9, wherein the alumina-containing refractory balls have a size of between 5 and 30 cm.

11. The device as claimed in claim 1, wherein the alumina-containing refractory balls comprise at least 25% by weight of alumina.

12. The device as claimed in claim 1, wherein the furnace is equipped with at least one overhead burner, the flame of which is emitted above the surface of the molten batch materials and below the means for supporting the solid raw material in the vertical duct.

13. A process for preparing molten batch material comprising the melting a batch material by the device of claim 1, raw material comprising fragments of mineral wool being introduced into the furnace below the surface of the molten batch material, raw material being introduced into the vertical duct, descending in the vertical duct and being heated therein by the combustion flue gases until the raw material melts and flows onto the surface of the molten batch material, the submerged burner operating by combustion of fuel gas and of an oxidizer comprising at least 80% by volume of oxygen.

14. The process as claimed in claim 13, wherein the raw material introduced into the vertical duct is such that at least 80% of its mass consists of grains with a size of greater than 30 mm.

15. The process as claimed in claim 13, wherein the raw material comprising fragments of mineral wool introduced below the surface of the molten batch material comprises raw material different from the fragments of mineral wool, at least 80% of the mass of the different raw material consisting of grains with a size of less than 30 mm.

16. The process as claimed in claim 13, wherein the mass of raw material introduced below the surface of the molten batch material represents 5% to 70% of the sum of the masses of all the raw materials introduced into the device.

17. The process as claimed in claim 13, wherein the mass of fragments of mineral wool represents 50% to 100% of the sum of the mass of raw material introduced below the surface of the bath of batch material.

18. The process as claimed in claim 13, wherein the fragments of mineral wool are bound.

19. The process as claimed in claim 13, wherein the fragments of mineral wool comprise, excluding binding compound, 30% to 75% by weight of SiO₂ and 5% to 40% by weight of (CaO+MgO).

20. The process as claimed in claim 13, wherein the combustion in the furnace is sufficiently energetic so that the combustion flue gases are hot enough to melt the raw material in the vertical duct above the system for supporting the solid raw material in the vertical duct.

21. The process as claimed in claim 13, wherein the system for supporting the solid raw material in the vertical duct comprises a grate on which alumina-containing refractory balls rest, said refractory balls enriching the molten batch material with alumina.

22. The process as claimed in claim 13, wherein the molten batch material is brought into the furnace at a temperature above 1400° C. and below 1600° C.

23. The process as claimed in claim 13, wherein the molten batch material comprises 30% to 75% by weight of SiO₂ and 5% to 40% by weight of (CaO+MgO).
